(19) United States
(12) Patent Application Publication
(10) Pub. No.: US 2015/0091809 A1
(43) Pub. Date: Apr. 2, 2015

(54) SKEUOMORPHIC EBOOK AND TABLET

(71) Applicants: Analia Ibargoyen, San Francisco, CA (US); Joshua J. Ratcliff, San Jose, CA (US)

(72) Inventors: Analia Ibargoyen, San Francisco, CA (US); Joshua J. Ratcliff, San Jose, CA (US)

(21) Appl. No.: 14/040,311

(22) Filed: Sep. 27, 2013

(51) Int. Cl. G06F 3/0483; G06F 3/01; G06F 3/0488; G06F 3/041

(52) U.S. Cl. CPC G06F 3/0483; G06F 3/041; G06F 3/016; G06F 3/0488
USPC 345/173

(57) ABSTRACT

Methods and apparatus relating to skeuomorphic e-book (electronic book) and tablet are described. In one embodiment, a touch input at a portion of a computing device is identified. The portion of the computing device includes one or more of: a top surface of the computing device, a bottom surface of the computing device opposite the top surface, an angled side surface of the computing device coupled between an edge of the top surface and an edge of the bottom surface, and a curved side of the computing device opposite the angled side surface. Other embodiments are also claimed and disclosed.

### FIELD

The present disclosure generally relates to the field of electronics. More particularly, an embodiment relates to skeuomorphic e-book (electronic book) and tablet.

### BACKGROUND

E-book (or electronic book) readers are common products in the market. They are digital, portable, and most importantly, dynamic—their content can be changed via network communication. This is of course not the case for tangible, printed paper in physical books (probably one motivation for having e-book readers in the first place). Nonetheless, the form factors of all e-book readers available now (such as the Nook® or Kindle™ e-book readers) fail to reproduce the natural affordances of real books. For example, embodied in a general, tablet-like form factor, e-book readers limit the freedom of interaction, physical, and spatial references and feedback that physical books provide.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 11-13 illustrate block diagrams of embodiments of computing systems, which may be utilized to implement various embodiments discussed herein.

FIGS. 2A-10 illustrate various form factor features, according to some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As discussed above, embodied in a general, tablet-like form factor, e-book readers limit the freedom of interaction, physical, and spatial references and feedback that physical books provide. Additionally, they do not allow readers to flip through pages, skimming for content, or to turn pages in sized groups (e.g., that are visibly proportional to the length of the book). They also do not provide a visual way of knowing how far ahead in the book a reader is. Furthermore, they do not support bookmarks that are visually and physically apparent (e.g., while reading at all times).

Moreover, the current form factors of e-book readers distance the user from the content. However, the impermanence of the digital screen should be the only detractor. Instead, small screens reduced by wide bezels and unnecessary buttons, along with lacking haptic (e.g., generally referring to any form of non-verbal communication involving touch), spatial, visual, and tactile cues result in a diminished reading experience, lacking the natural and less constraining interactions of physical books. The form factor thus discourages a large demographic of users from purchasing these devices, as well as limits the experience and interaction of those who do.

Some embodiments provide skeuomorphic e-book and/or tablet devices. As discussed herein, a skeuomorph generally refers to a derivative object which retains the design qualities necessary from the original object, e.g., to promote user comfort in adoption. To this end, an embodiment provides a new form factor for a skeuomorphic e-book reader, which may afford the natural interactions as well as haptic, tactile, and visual cues observed in physical books. Further, the form factor may be used for a tablet, creating a hybrid e-book reader and tablet form factor.

However, all embodiments are not limited to e-book readers or tablets, and the techniques discussed herein may be applied to any mobile (or handheld) device such as a smartphone, UMPC (Ultra-Mobile Personal Computer), laptop computer, Ultrabook™ computing device, smart watch, smart television, smart glasses, etc., e.g., that includes a touch device to receive user input. The form factor may also improve the affordances of physical books, e.g., given that there is only one page to focus on at a time and/or no moving pages close on the reading material unless the device is held by the hands.

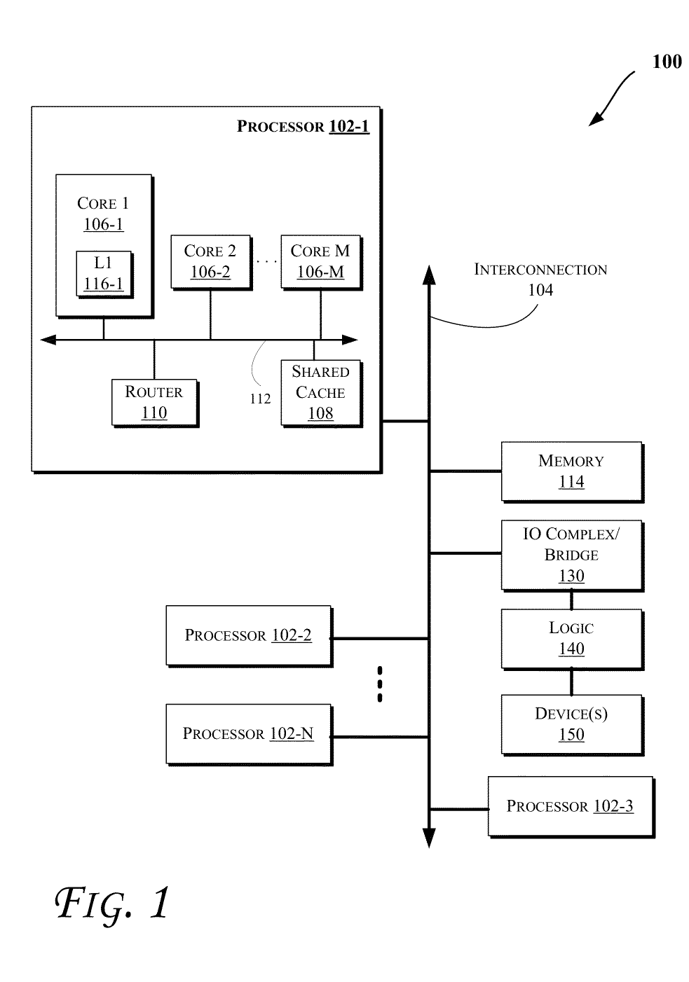

The techniques discussed herein may be used in any type of a computing system with power consumption settings, such as the systems discussed with reference to FIGS. 1 and 11-13 (which may include a mobile device such as a tablet, e-book reader, smartphone, UMPC, laptop computer, Ultrabook computing device, smart watch, smart glasses, etc.). More particularly, FIG. 1 illustrates a block diagram of a computing system 100, according to an embodiment. The system 100 may include one or more processors 102-1 through 102-N (generally referred to herein as “processors 102” or “processor 102”). The processors 102 may communicate via an interconnection network or bus 104. Each processor may include various components some of which are only discussed with reference to processor 102-1 for clarity. Accordingly, each of the remaining processors 102-2 through 102-N may include the same or similar components discussed with reference to the processor 102-1.

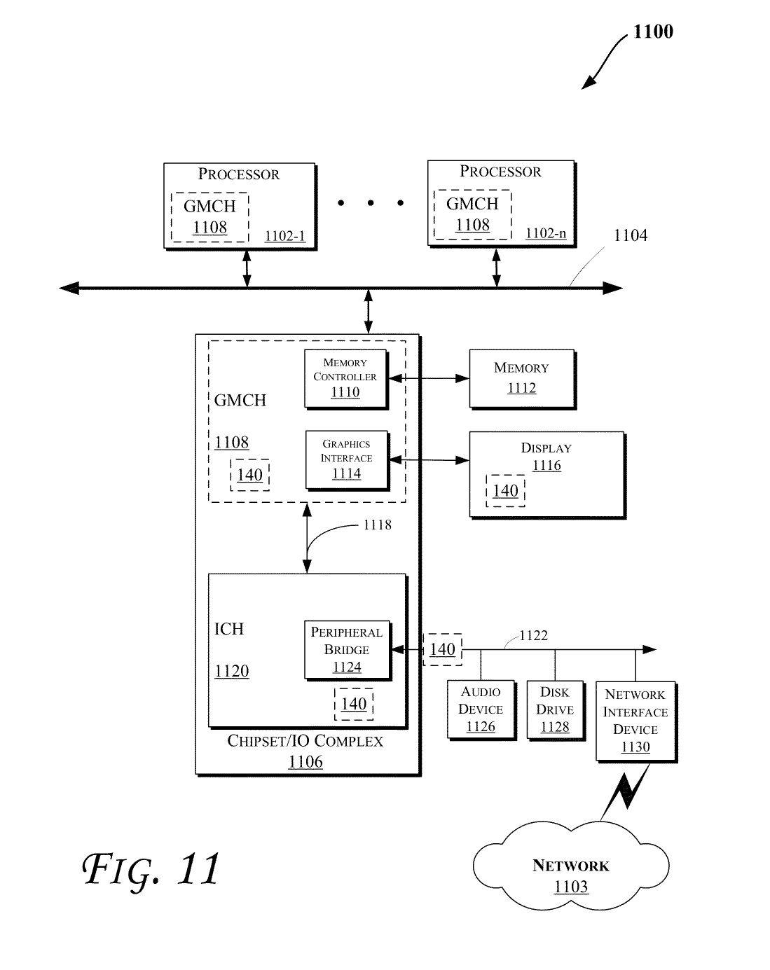

In an embodiment, the processor 102-1 may include one or more processor cores 106-1 through 106-M (referred to herein as “cores 106” or more generally as “core 106”), a shared cache 108, and/or a router 110. The processor cores 106 may be implemented on a single integrated circuit (IC) chip. Moreover, the chip may include one or more shared and/or private caches (such as cache 108), buses or interconnections (such as a bus or interconnection network 112), memory controllers (such as those discussed with reference to FIGS. 11-13), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The shared cache 108 may store data (e.g., including instructions) that are utilized by one or more components of the processor 102-1, such as the cores 106. For example, the shared cache 108 may locally cache data stored in a memory 114 for faster access by components of the processor 102. In an embodiment, the cache 108 may include a mid-level cache (such as a level 2 (L2), a level 3 (L3), a level 4 (L4), or other levels of cache), a last level cache (LLC), and/or combinations thereof. Moreover, various components of the processor 102-1 may communicate with the shared cache 108 directly, through a bus (e.g., the bus 112), and/or a memory controller or hub. As shown in FIG. 1, in some embodiments, one or more of the cores 106 may include a level 1 (L1) cache 116-1 (generally referred to herein as “L1 cache 116”).

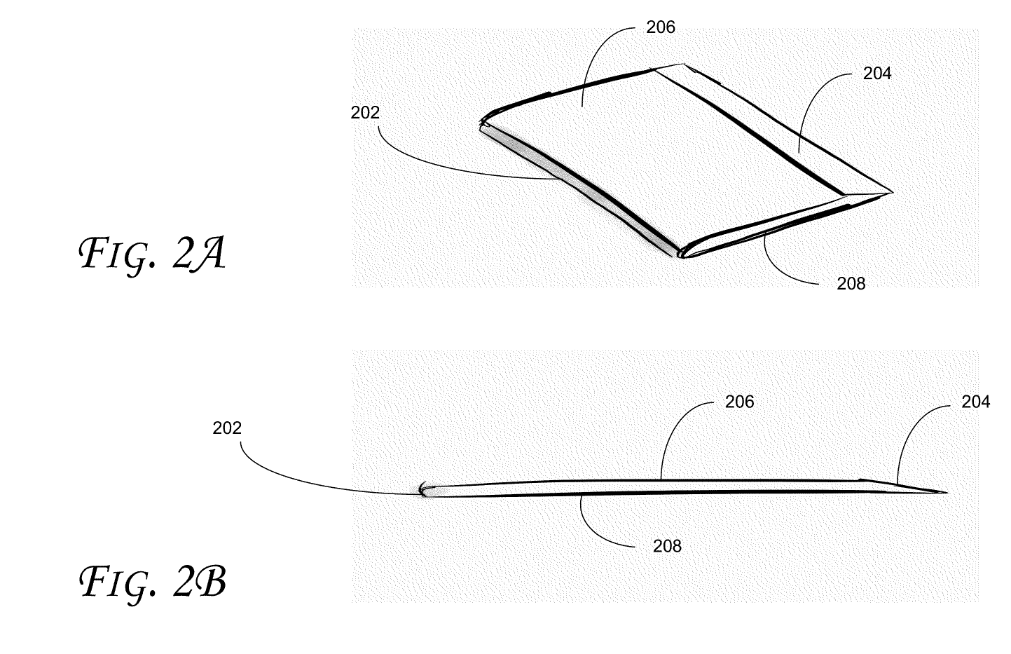

In one embodiment, logic 140 receives or detects input touch from one or more devices 150 (such as one or more of a touch display, a motion sensor (such as an optical or ultrasonic motion sensor), etc.). For example, logic 140 is coupled between I/O complex 130 and one or more devices 150 and detects/receives touch input from the one or more devices 150 to implement the embodiments discussed herein, e.g., with reference to FIGS. 2-10. While I/O complex 130 may be used in some embodiments, other types of logic such as a bridge, control logic, Platform Controller Hub (PCH), etc. may be used instead of or in addition to a I/O complex to couple logic 140 to the system 100 (e.g., via bus/interconnection 104).

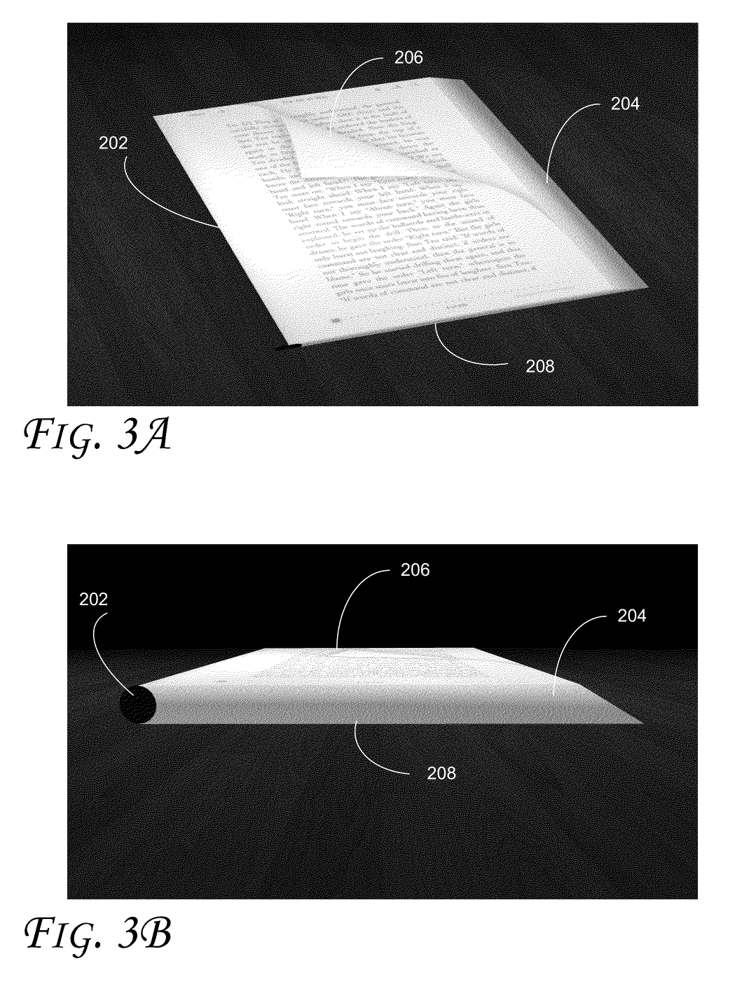

FIGS. 2A-10 illustrate various form factor features, according to some embodiments. In an embodiment, a form factor consists of (e.g., a thin) rectangular shape, with an ergonomically curved side surface 202 on a first side, and an angled/tapered side surface 204 on a second side (opposite the first side) such as shown in FIGS. 2A-3B. This orientation could be flipped for left-handed users (e.g., simply by turning the device around), but for simplicity this description will refer to the originally described orientation. FIGS. 2A and 3A illustrate perspective views of a computing device, according to some embodiments. FIGS. 2B and 3B illustrate side views of a computing device, according to some embodiments.

In an embodiment, the top facing surface 206 and the angled side surface 204 are touchscreens (e.g., including a touchscreen display device) capable of receiving touch input (which is subsequently processed by logic 140 as discussed herein). These surfaces may also offer dynamic tactile feedback by using pneumatically-actuated tactile touchscreens technology (including the technology offered by Tactus™ Technology). The top 206 and bottom 208 sides of the form factor could also be touchscreen surfaces, e.g., offering similar interactions as the ones that will be described for the angled side surface, but could also simply be plastic or metal/metallic bezels.

Furthermore, in some embodiments, by including accelerometers/gyros, audio feedback through speakers, and haptic feedback through piezoelectric actuators (such as those which feel more like a “flick” than a vibration), less constrained and/or more natural forms of interaction are allowed. For example, these may include intuitive forms of: page turning, chunk page turning, flipping through pages or skimming, indicating visuospatial reading progress, as well as visual and tactile bookmarking, as will be further discussed herein with reference to the following figures.

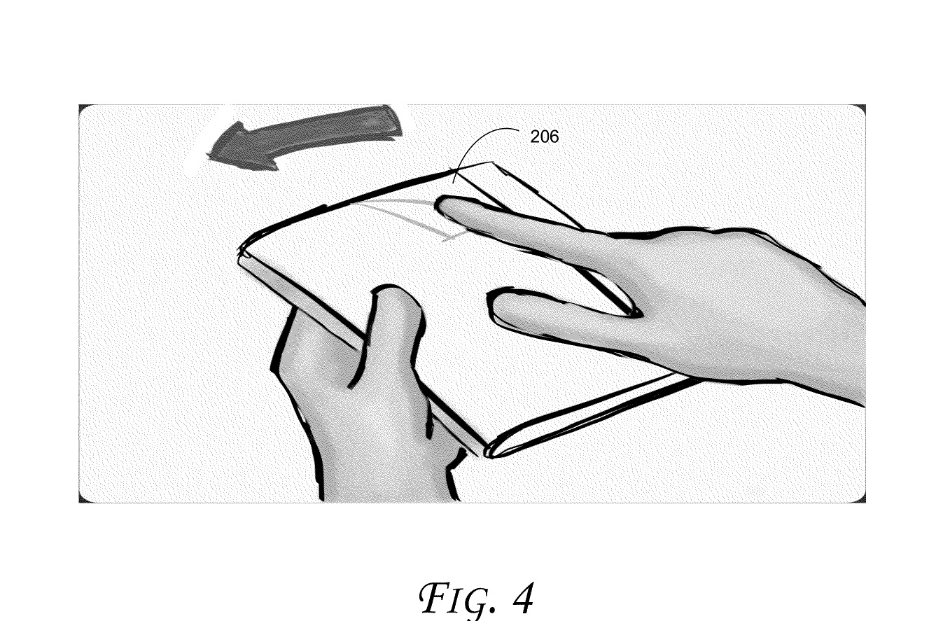

FIG. 4 illustrates a page turning interaction feature, according to an embodiment. The page turning interaction may include haptic and/or audio feedback. For example, by placing a finger on the top surface 206 of the screen and sliding it to towards the left edge (or right edge for a left-handed implementation) to turn the page, the user would observe a page curl animation leading to a page turn. Audio feedback (of a page turn) and/or haptic feedback (through a very subtle and short “flick” vibration) may also be provided.

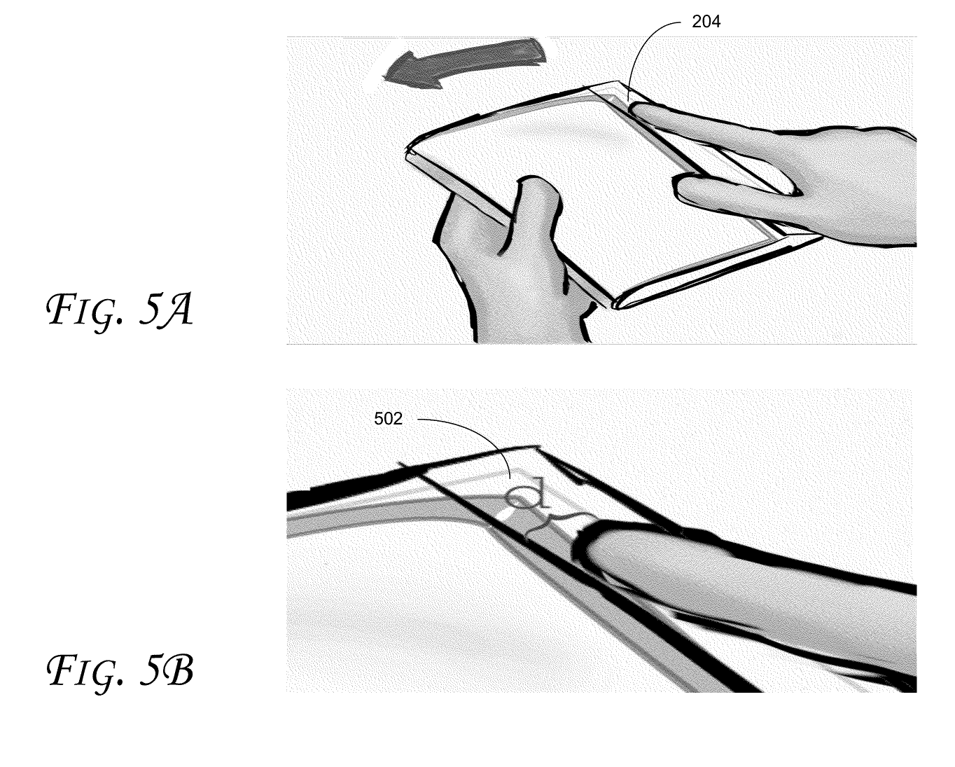

FIGS. 5A and 5B illustrate a chunk page turning interaction feature, according to an embodiment. For example, by placing a finger over the angled right side surface 204, a user can select pages in chunk (or as a group) and turn them all at once (similar animations and general finger movement to the single page turn of FIG. 4 may be used). The size of the page chunk to be turned is determined by how far along the width of the angled surface the finger is placed (defined by distance d 502, as shown in FIG. 5B which is an enlargement of the portion of FIG. 5A where the user finger touches the angled side 204). The finger position is thus used as a way of determining how many pages to turn by proportionately equating the distance d to the total length of the book or to the number of pages left to be read. The user could “flick” the page chunk to turn it or follow the turning through the top surface of the e-book reader. Also, pressure sensing (e.g., the amount of finger pressure detected on the angled side 204) may be used to determined how many pages to turn in some embodiments.

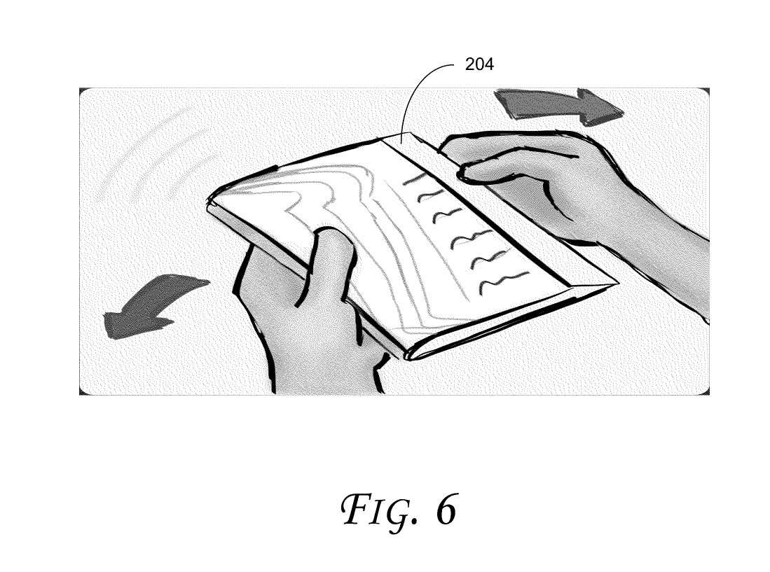

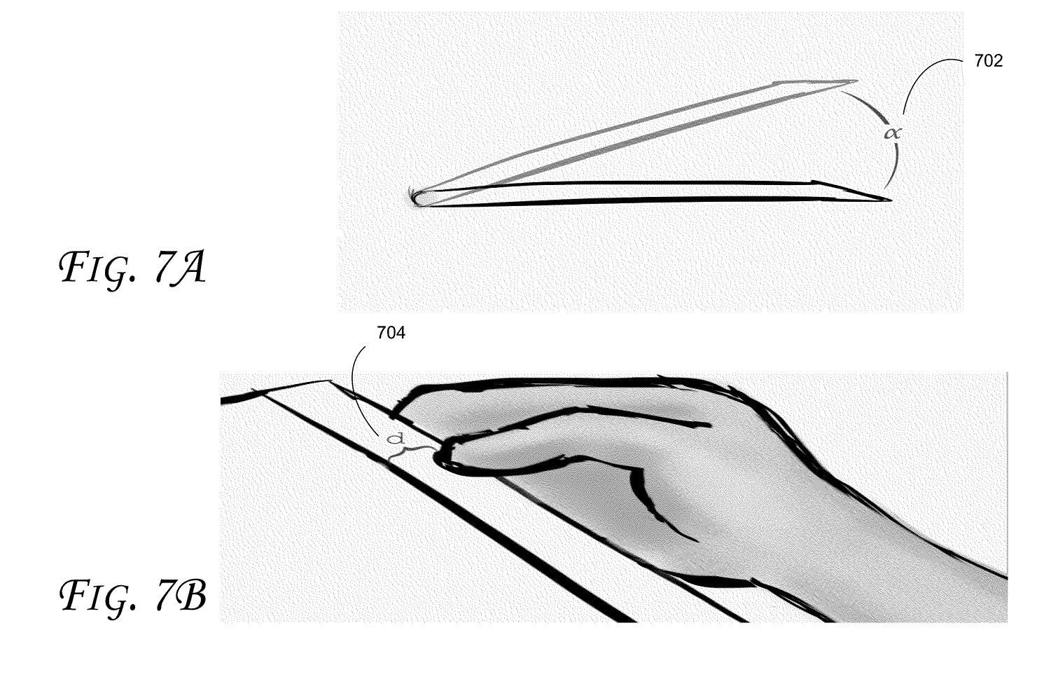

FIG. 6 illustrates a page flipping or skimming interaction feature, e.g., with optional haptic and/or audio feedback, according to some embodiments. For example, by holding a book in the left hand, placing the right thumb on the angled side surface 204, and tilting the e-book reader using the left hand as a pivot point, a user can flip through pages to look for content or skim read. The rate at which the pages would flip through, as well as what page to start from can be determined by the tilt angle alpha 702 (shown in FIG. 7A) and/or by the position of the right thumb along the angled side surface 204 at a distance d 704 (see, e.g., FIG. 7B).

Moreover, different forms of feedback provided per the current rate of page flipping may further enhance this experience and strengthen physical and spatial cues to enable flexible and more intuitive forms of interaction. These feedback forms may include visual feedback (animated pages flipping on the top and angled surfaces), audio feedback (sounds of pages flipping), haptic feedback (e.g., through a piezoelectric actuator creating a “flick” sensation, in short bursts for each page flipped), and tactile feedback (e.g., along the angled surface, sequentially actuating extruding vertical lines one at a time, simulating the pages physically flipping under the thumb).

In an embodiment, a flexible touchscreen may be used for the top surface 204 and/or side 204. However, given that some e-book readers generally include a rigid surface that would not flex as the pages are flipped through (allowing the right thumb to naturally slide along the remaining pages), there are two other possible interaction schemes: (1) Right Thumb Static: where the right thumb statically placed at distance d along the angled surface or the page flipping would start at the current page and end at the page indicated by the right thumb's position (the page flipping rate would be determined by the angle alpha 702); or (2) Right Thumb Moving: where the right thumb slowly moves along the angled surface (increasing distance d 704) or this being analogous to flipping through the pages of a physical book. The page flipping rate for the latter may be determined by the angle alpha 702 and the currently flipped page may be the one selected by the position of the right thumb.

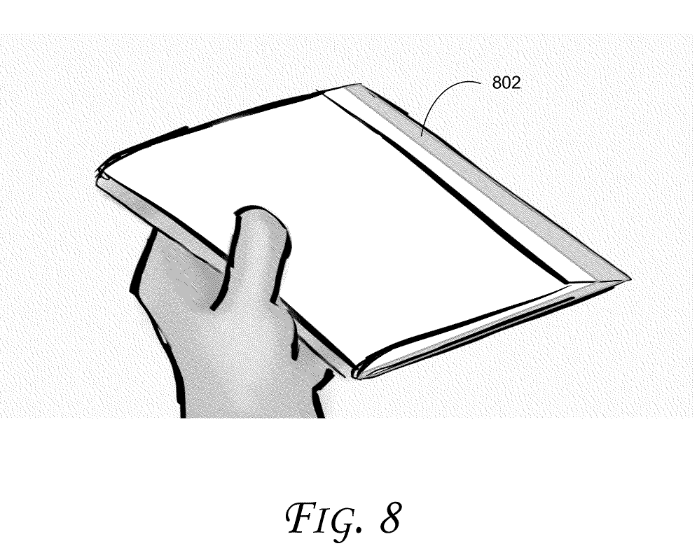

FIG. 8. illustrates a visuospatial reading progress feature, according to an embodiment. For example, to indicate reading progress in a spatially meaningful way, progress would be indicated by solidly coloring a portion of the side surface 802 (see, e.g., FIG. 8). As the reading of content progresses, the “grayed-out” section 802 would grow in increments, e.g., proportional to the number of pages read in view of the total length of the reading content.

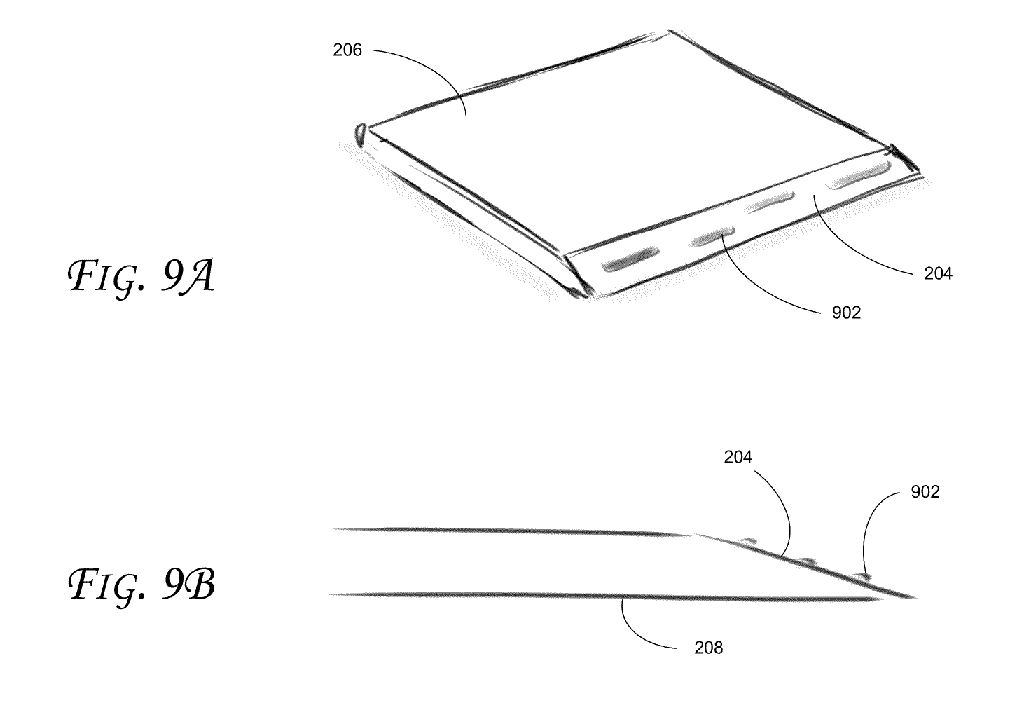

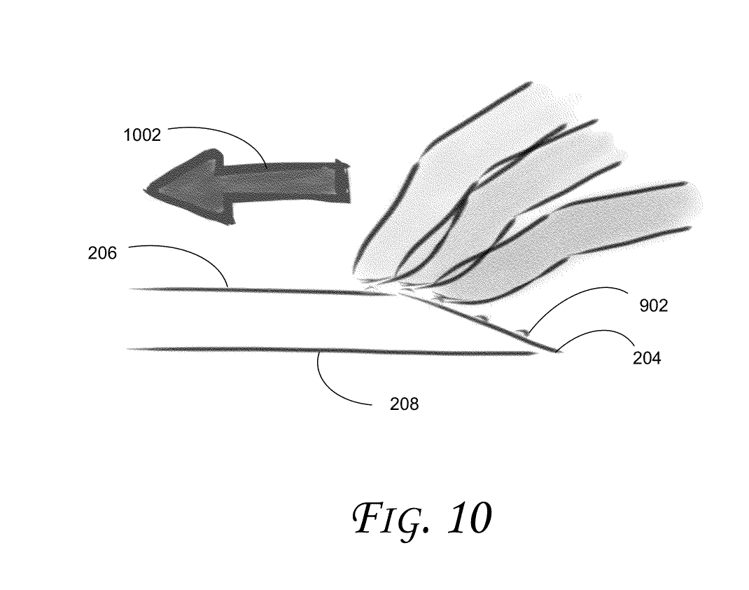

FIGS. 9A and 9B illustrate dynamic visuospatial and/or tactile bookmarks in perspective and side views, respectively, according to some embodiments. FIG. 10 illustrates a side view of a usage model for the dynamic tactile bookmarks, according to an embodiment.

In some embodiments, the tactile touchscreens (e.g., on the top and side angle surfaces 204/206) may be leveraged to provide visual and/or tactile cues for bookmarks and/or chapter divisions (see, e.g., FIGS. 9A-10). These could be seen on any of the touchscreen side surfaces 204/206/208 and could be felt on the angled side surface 204 of the e-book reader. In various embodiments, the bookmarks could be color coded and manually added or already integrated with the reading material. An additional bookmark (that could be exclusively shown on the top side surface 206) could automatically or manually mark reading progress when skimming or flipping through pages.

When choosing to access the content marked by any of the bookmarks, the tactile and visual bookmark would dynamically follow the finger as it pushes the bookmark over to turn to that section (see, e.g., large arrow 1002 in FIG. 10). This tactile and visual feedback may even follow through a small portion of the top surface, e.g., simulating the natural feedback of turning a physical bookmark. These physical and visual cues would allow the reader to access content more naturally. Also, in one embodiment, the bookmarks are provided by inserting air (or other gas) into blocks formed by an extra (e.g., translucent) layer of material over the surfaces of the device.

FIG. 11 illustrates a block diagram of a computing system 1100 in accordance with an embodiment. The computing system 1100 may include one or more central processing unit(s) (CPUs) 1102 or processors that communicate via an interconnection network (or bus) 1104. The processors 1102 may include a general purpose processor, a network processor (that processes data communicated over a computer network 1103), or other types of a processor (including a reduced instruction set computer (RISC) processor or a complex instruction set computer (CISC)).

Moreover, the processors 1102 may have a single or multiple core design. The processors 1102 with a multiple core design may integrate different types of processor cores on the same integrated circuit (IC) die. Also, the processors 1102 with a multiple core design may be implemented as symmetrical or asymmetrical multiprocessors. In an embodiment, one or more of the processors 1102 may be the same or similar to the processors 102 of FIG. 1. For example, one or more components of system 1100 may include one or more of items 130, 140, and 150 discussed with reference to FIGS. 1-10. As shown, logic 140 may be provided in various locations in the system (however, logic 140 may be provided in locations including/excluding those shown). Also, the operations discussed with reference to FIGS. 1-10 may be performed by one or more components of the system 1100.

A chipset 1106 may also communicate with the interconnection network 1104. The chipset 1106 may include a graphics memory control hub (GMCH) 1108, which may be located in various components of system 1100 (such as those shown in FIG. 11). The GMCH 1108 may include a memory controller 1110 that communicates with a memory 1112 (which may be the same or similar to the memory 114 of FIG. 1). The memory 1112 may store data, including sequences of instructions, that may be executed by the CPU 1102, or any other device included in the computing system 1100. In one embodiment, the memory 1112 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 1104, such as multiple CPUs and/or multiple system memories.

The GMCH 1108 may also include a graphics interface 1114 that communicates with a display device 1116. In one embodiment, the graphics interface 1114 may communicate with the display device 1116 via an accelerated graphics port (AGP) or Peripheral Component Interconnect (PCI) (or PCI express (PCIe) interface). In an embodiment, the display 1116 (such as a flat panel display) may communicate with the graphics interface 1114 through, for example, a signal converter that translates a digital representation of an image stored in a storage device such as video memory or system memory into display signals that are interpreted and displayed by the display 1116. The display signals produced by the display device may pass through various control devices before being interpreted by and subsequently displayed on the display 1116.

A hub interface 1118 may allow the GMCH 1108 and an input/output control hub (ICH) 1120 to communicate. The ICH 1120 may provide an interface to I/O device(s) that communicate with the computing system 1100. The ICH 1120 may communicate with a bus 1122 through a peripheral bridge (or controller) 1124, such as a peripheral component interconnect (PCI) bridge, a universal serial bus (USB) controller, or other types of peripheral bridges or controllers. The bridge 1124 may provide a data path between the CPU 1102 and peripheral devices. Other types of topologies may be utilized. Also, multiple buses may communicate with the ICH 1120, e.g., through multiple bridges or controllers. Moreover, other peripherals in communication with the ICH 1120 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 1122 may communicate with an audio device 1126, one or more disk drive(s) 1128, and a network interface device 1130 (which is in communication with the computer network 1103). Other devices may communicate via the bus 1122. Also, various components (such as the network interface device 1130) may communicate with the GMCH 1108 in some embodiments. In addition, the processor 1102 and the GMCH 1108 may be combined to form a single chip. Furthermore, a graphics accelerator may be included within the GMCH 1108 in other embodiments.

Furthermore, the computing system 1100 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 1128), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

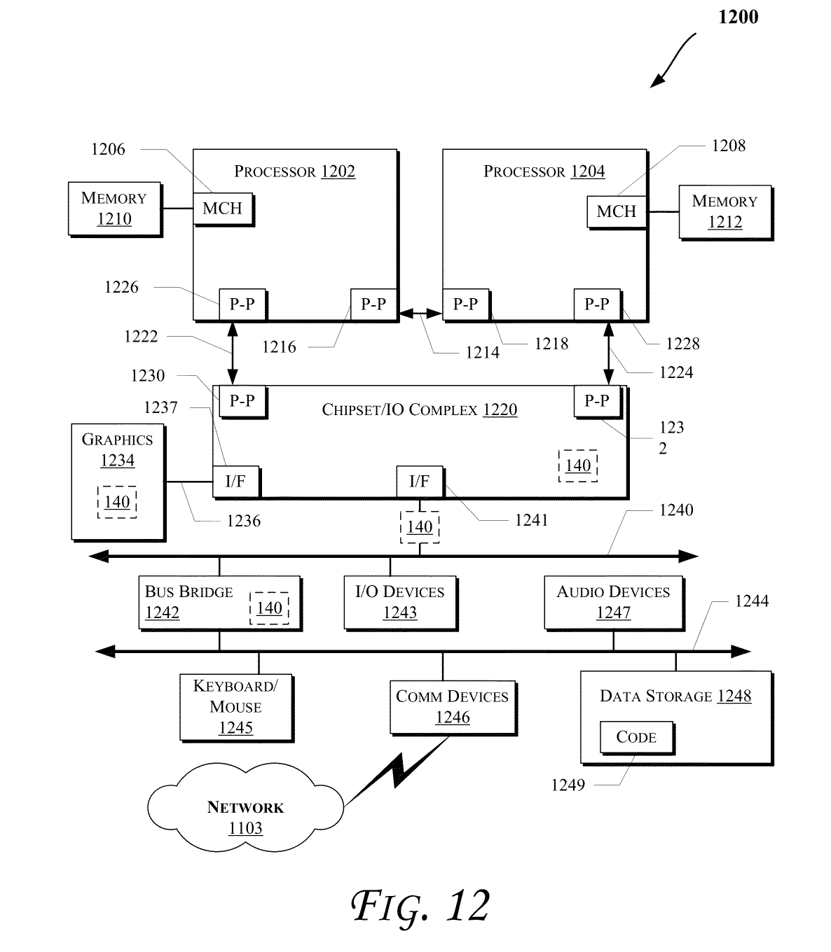

FIG. 12 illustrates a computing system 1200 that is arranged in a point-to-point (PtP) configuration, according to an embodiment. In particular, FIG. 12 shows a system where processors, memory, and input/output devices are interconnected by a number of point-to-point interfaces. The operations discussed with reference to FIGS. 1-11 may be performed by one or more components of the system 1200.

As illustrated in FIG. 12, the system 1200 may include several processors, of which only two, processors 1202 and 1204 are shown for clarity. The processors 1202 and 1204 may each include a local memory controller hub (MCH) 1206 and 1208 to enable communication with memories 1210 and 1212. The memories 1210 and/or 1212 may store various data such as those discussed with reference to the memory 1112 of FIG. 11.

In an embodiment, the processors 1202 and 1204 may be one of the processors 1102 discussed with reference to FIG. 11. The processors 1202 and 1204 may exchange data via a point-to-point (PtP) interface 1214 using PtP interface circuits 1216 and 1218, respectively. Also, the processors 1202 and 1204 may each exchange data with a chipset 1220 via individual PtP interfaces 1222 and 1224 using point-to-point interface circuits 1226, 1228, 1230, and 1232. The chipset 1220 may further exchange data with a graphics circuit 1234 via a graphics interface 1236, e.g., using a PtP interface circuit 1237.

At least one embodiment may be provided within the processors 1202 and 1204. For example, one or more components of system 1200 may include one or more of items 130, 140, and 150 of FIGS. 1-11, including located within the processors 1202 and 1204. As shown, logic 140 may be provided in various locations in the system (however, logic 140 may be provided in locations including/excluding those shown). Also, other embodiments, may exist in other circuits, logic units, or devices within the system 1200 of FIG. 12. Furthermore, other embodiments may be distributed throughout several circuits, logic units, or devices illustrated in FIG. 12.

The chipset 1220 may communicate with a bus 1240 using a PtP interface circuit 1241. The bus 1240 may communicate with one or more devices, such as a bus bridge 1242 and I/O devices 1243. Via a bus 1244, the bus bridge 1242 may communicate with other devices such as a keyboard/mouse 1245, communication devices 1246 (such as modems, network interface devices, or other communication devices that may communicate with the computer network 1103), audio I/O device 1247, and/or a data storage device 1248. The data storage device 1248 may store code 1249 that may be executed by the processors 1202 and/or 1204.

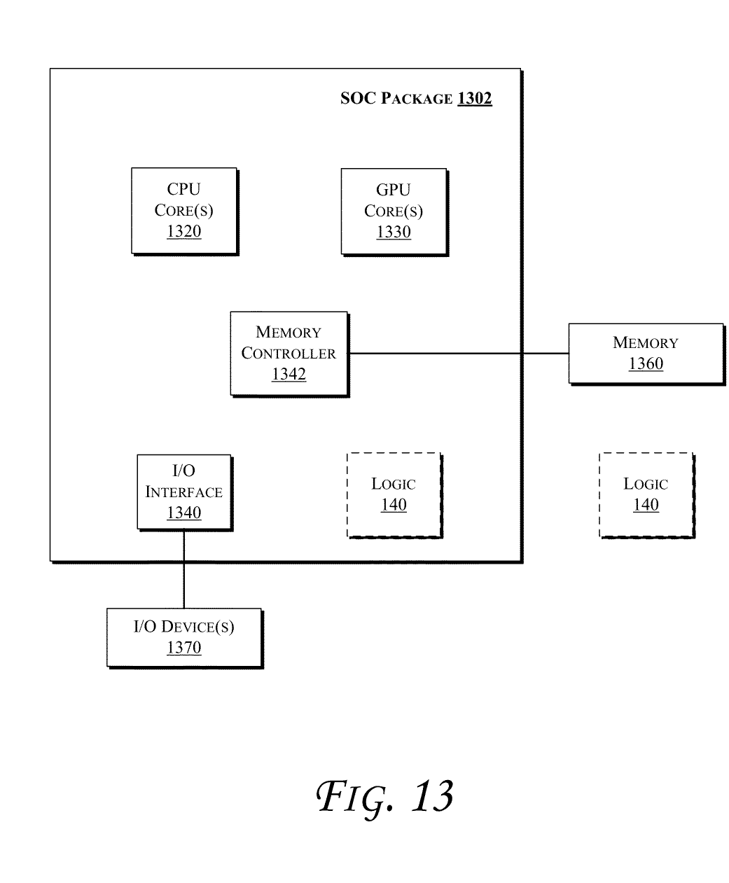

In some embodiments, one or more of the components discussed herein can be embodied as a System On Chip (SOC) device. FIG. 13 illustrates a block diagram of an SOC package in accordance with an embodiment. As illustrated in FIG. 13, SOC 1302 includes one or more Central Processing Unit (CPU) cores 1320, one or more Graphics Processor Unit (GPU) cores 1330, an Input/Output (I/O) interface 1340, and a memory controller 1342. Various components of the SOC package 1302 may be coupled to an interconnect or bus such as discussed herein with reference to the other figures. Also, the SOC package 1302 may include more or less components, such as those discussed herein with reference to the other figures. Further, each component of the SOC package 1320 may include one or more other components, e.g., as discussed with reference to the other figures herein. In one embodiment, SOC package 1302 (and its components) is provided on one or more Integrated Circuit (IC) die, e.g., which are packaged into a single semiconductor device.

As illustrated in FIG. 13, SOC package 1302 is coupled to a memory 1360 (which may be similar to or the same as memory discussed herein with reference to the other figures) via the memory controller 1342. In an embodiment, the memory 1360 (or a portion of it) can be integrated on the SOC package 1302.

The I/O interface 1340 may be coupled to one or more I/O devices 1370, e.g., via an interconnect and/or bus such as discussed herein with reference to other figures. I/O device(s) 1370 may include one or more of a keyboard, a mouse, a touchpad, a display, an image/video capture device (such as a camera or camcorder/video recorder), a touchscreen, a speaker, or the like. Furthermore, SOC package 1302 may include/integrate the logic 140 in an embodiment. Alternatively, the logic 140 may be provided outside of the SOC package 1302 (i.e., as a discrete logic).

The following examples pertain to further embodiments. Example 1 includes an apparatus comprising: logic, the logic at least partially comprising hardware logic, to identify a touch input at a portion of a computing device, wherein the portion of the computing device is to comprise: a top surface of the computing device and an angled side surface of the computing device coupled between an edge of the top surface and an edge of a bottom surface of the computing device. Example 2 includes the apparatus of example 1, wherein the angled side surface is tapered between one end of the angled side surface, adjacent to the top surface edge, and another end of the angled side surface adjacent to the bottom surface edge. Example 3 includes the apparatus of example 1, wherein at least one of the top surface, the bottom surface, or the angled side surface is to comprise a touchscreen device. Example 4 includes the apparatus of example 1, wherein at least one of the top surface, the bottom surface, or the angled side surface is to provide dynamic tactile feedback. Example 5 includes the apparatus of example 1, wherein the touch input is to cause one or more of: a page turn operation, a chunk page turn operation, or a page skim operation. Example 6 includes the apparatus of example 5, wherein the chunk page turn operation is to be performed based at least in part on: how far along a width of the angled side surface the touch input is identified or an amount of pressure identified on the angled side surface. Example 7 includes the apparatus of example 5, wherein the page skim operation is to be performed based at least in part on one or more of: a rate at which pages would flip through, a tilt angle of the computing device, or an identified position of the touch input along the angled side surface. Example 8 includes the apparatus of example 1, wherein the angled side surface is to provide one or more bookmarks. Example 9 includes the apparatus of example 8, wherein the one or more bookmarks are tactile. Example 10 includes the apparatus of example 1, wherein the angled side surface is to provide one or more visuospatial progress markers. Example 11 includes the apparatus of example 1, wherein at least one of the top surface, the bottom surface, or the angled side surface is to provide dynamic tactile feedback in response to a pneumatically-actuated tactile touchscreen device. Example 12 includes the apparatus of example 1, wherein at least one of the top surface or the bottom surface is to comprise a plastic or metallic bezel. Example 13 includes the apparatus of example 1, wherein the touch input is to cause tactile, haptic, or audio feedback. Example 14 includes the apparatus of example 1, wherein the portion of the computing device is to comprise a curved side of the computing device opposite the angled side surface.

Example 15 includes a method comprising: identifying a touch input at a portion of a computing device, wherein the portion of the computing device comprises: a top surface of the computing device and an angled side surface of the computing device coupled between an edge of the top surface and an edge of a bottom surface of the computing device. Example 16 includes the method of example 15, further comprising providing dynamic tactile feedback at least one of the top surface, the bottom surface, or the angled side surface. Example 17 includes the method of example 15, further comprising the touch input causing one or more of: a page turn operation, a chunk page turn operation, or a page skim operation. Example 18. A computer-readable medium comprising one or more instructions that when executed on a processor configure the processor to perform one or more operations of any of examples 15 to 17. Example 19. An apparatus comprising means for performing one or more operations of any of examples 15 to 17.

Example 20 includes a system comprising: a computing device having a processor with one or more processor cores; and logic, the logic at least partially comprising hardware logic, to identify a touch input at a portion of the computing device, wherein the portion of the computing device is to comprise: a top surface of the computing device and an angled side surface of the computing device coupled between an edge of the top surface and an edge of a bottom surface of the computing device. Example 21 includes the system of example 20, wherein the angled side surface is tapered between one end of the angled side surface, adjacent to the top surface edge, and another end of the angled side surface adjacent to the bottom surface edge. Example 22 includes the system of example 20, wherein at least one of the top surface, the bottom surface, or the angled side surface is to comprise a touchscreen device. Example 23 includes the system of example 20, wherein at least one of the top surface, the bottom surface, or the angled side surface is to provide dynamic tactile feedback. Example 24 includes the system of example 20, wherein the touch input is to cause one or more of: a page turn operation, a chunk page turn operation, or a page skim operation. Example 25 includes the system of example 20, wherein the angled side surface is to provide one or more bookmarks. Example 26 includes the system of example 20, wherein the angled side surface is to provide one or more visuospatial progress markers. Example 27 includes the system of example 20, wherein at least one of the top surface, the bottom surface, or the angled side surface is to provide dynamic tactile feedback in response to a pneumatically-actuated tactile touchscreen device. Example 28 includes the system of example 20, wherein at least one of the top surface or the bottom surface is to comprise a plastic or metallic bezel. Example 29 includes the system of example 20, wherein the touch input is to cause tactile, haptic, or audio feedback. Example 30 includes the system of example 20, wherein the portion of the computing device is to comprise a curved side of the computing device opposite the angled side surface.

In various embodiments, the operations discussed herein, e.g., with reference to FIGS. 1-13, may be implemented as hardware (e.g., logic circuitry), software, firmware, or combinations thereof, which may be provided as a computer program product, e.g., including (e.g., a non-transitory) machine-readable or computer-readable medium having stored thereon instructions (or software procedures) used to program a computer to perform a process discussed herein. The machine-readable medium may include a storage device such as those discussed with respect to FIGS. 1-13.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection).

Reference in the specification to “one embodiment,” “an embodiment,” or “some embodiments” means that a particular feature, structure, or characteristic described in connection with the embodiment(s) may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic, the logic at least partially comprising hardware logic, to identify a touch input at a portion of a computing device,
wherein the portion of the computing device is to comprise: a top surface of the computing device and an angled side surface of the computing device coupled between an edge of the top surface and an edge of a bottom surface of the computing device.

2. The apparatus of claim 1, wherein the angled side surface is tapered between one end of the angled side surface, adjacent to the top surface edge, and another end of the angled side surface adjacent to the bottom surface edge.

3. The apparatus of claim 1, wherein at least one of the top surface, the bottom surface, or the angled side surface is to comprise a touchscreen device.

4. The apparatus of claim 1, wherein at least one of the top surface, the bottom surface, or the angled side surface is to provide dynamic tactile feedback.

5. The apparatus of claim 1, wherein the touch input is to cause one or more of: a page turn operation, a chunk page turn operation, or a page skim operation.

6. The apparatus of claim 5, wherein the chunk page turn operation is to be performed based at least in part on: how far along a width of the angled side surface the touch input is identified or an amount of pressure identified on the angled side surface.

7. The apparatus of claim 5, wherein the page skim operation is to be performed based at least in part on one or more of: a rate at which pages would flip through, a tilt angle of the computing device, or an identified position of the touch input along the angled side surface.

8. The apparatus of claim 1, wherein the angled side surface is to provide one or more bookmarks.

9. The apparatus of claim 8, wherein the one or more bookmarks are tactile.

10. The apparatus of claim 1, wherein the angled side surface is to provide one or more visuospatial progress markers.

11. The apparatus of claim 1, wherein at least one of the top surface, the bottom surface, or the angled side surface is to provide dynamic tactile feedback in response to a pneumatically-actuated tactile touchscreen device.

12. The apparatus of claim 1, wherein at least one of the top surface or the bottom surface is to comprise a plastic or metallic bezel.

13. The apparatus of claim 1, wherein the touch input is to cause tactile, haptic, or audio feedback.

14. The apparatus of claim 1, wherein the portion of the computing device is to comprise a curved side of the computing device opposite the angled side surface.

15. A method comprising:
identifying a touch input at a portion of a computing device,
wherein the portion of the computing device comprises: a top surface of the computing device and an angled side surface of the computing device coupled between an edge of the top surface and an edge of a bottom surface of the computing device.

16. The method of claim 15, further comprising providing dynamic tactile feedback at least one of the top surface, the bottom surface, or the angled side surface.

17. The method of claim 15, further comprising the touch input causing one or more of: a page turn operation, a chunk page turn operation, or a page skim operation.

18. A computer-readable medium comprising one or more instructions that when executed on a processor configure the processor to perform one or more operations to:
identify a touch input at a portion of a computing device,
wherein the portion of the computing device comprises: a top surface of the computing device and an angled side surface of the computing device coupled between an edge of the top surface and an edge of a bottom surface of the computing device.

19. The computer-readable medium of claim 18, wherein the angled side surface is tapered between one end of the angled side surface, adjacent to the top surface edge, and another end of the angled side surface adjacent to the bottom surface edge.

20. The computer-readable medium of claim 18, wherein at least one of the top surface, the bottom surface, or the angled side surface comprises a touchscreen device.

21. The computer-readable medium of claim 18, further comprising one or more instructions that when executed on the processor configure the processor to perform one or more operations to cause provision of dynamic tactile feedback at least one of the top surface, the bottom surface, or the angled side surface.

22. The computer-readable medium of claim 18, further comprising one or more instructions that when executed on the processor configure the processor to perform one or more operations for the touch input causing one or more of: a page turn operation, a chunk page turn operation, or a page skim operation.

23. The computer-readable medium of claim 18, further comprising one or more instructions that when executed on the processor configure the processor to perform one or more operations to cause performance of the chunk page turn operation based at least in part on: how far along a width of the angled side surface the touch input is identified or an amount of pressure identified on the angled side surface.

24. The computer-readable medium of claim 18, further comprising one or more instructions that when executed on the processor configure the processor to perform one or more operations to cause performance of the page skim operation based at least in part on one or more of: a rate at which pages would flip through, a tilt angle of the computing device, or an identified position of the touch input along the angled side surface.

25. The computer-readable medium of claim 18, further comprising one or more instructions that when executed on the processor configure the processor to perform one or more operations to cause the angled side surface to provide one or more tactile bookmarks.
